(19) United States
(12) Patent Application Publication
(10) Pub. No.: US 2005/0060843 A1
(43) Pub. Date: Mar. 24, 2005

(54) Hinge for notebook computer

(76) Inventor: Tsung-Yung Hung, Taipei (TW)

Correspondence Address: SUPREME PATENT SERVICES, POST OFFICE BOX 2339, SARATOGA, CA, 95070, US

(21) Appl. No.: 10/669,987

(22) Filed: Sep. 23, 2003

(51) Int. Cl. E05D 3/10

(52) U.S. Cl. 16/367

(57) ABSTRACT

A hinge connects a screen to a master body of a notebook computer. The hinge includes a vertical pivot shaft mounted to a screen and a first connecting pivot seat through a plurality of springs and the corresponding nuts thereof, which enables the screen to pivot around the vertical pivot shaft relative to the master body; a first connecting pivot seat mounted to the vertical pivot shaft and a horizontal pivot shaft; a horizontal pivot shaft mounted to the first connecting pivot seat and a second connecting pivot seat, comprising an outer sleeve and an inner pivot shaft that enables the screen to pivot in horizontal relative to the master body; and a second connecting pivot seat mounted to the horizontal pivot shaft and the master body.

### BACKGROUND OF THE INVENTION

1. Field of the Invention

The present invention relates to a hinge for a notebook computer, which connects a screen to a master body of a notebook computer. The hinge can make a screen pivot respectively in vertical and in horizontal relative to a master body of a notebook computer.

2. The Related Art

A notebook computer has become a living and working necessity of people due to the convenience thereof. Its functions are promoted to a level of desk personal computer that largely increase the willing use of users.

To further increase added values of a notebook computer, more additional functions are designed for example the screen thereof being able to pivot and turn upward as the use of a tablet personal computer. However a conventional hinge for a notebook computer in the market now only uses a pivot shaft to support the screen that easily cause a vibration after long period use and even affect user's stable viewing.

Taiwan Patent Application No. 86220338 discloses an electronic device with a pivotally adjustable screen for example a notebook computer. The screen can be made only a little pivotal adjustment to solve a smaller view angle problem not be made 180-degree rotation and then turned upward to form a tablet personal computer. The electronic device comprises a master body, a screen and a pivot device. The screen is provided on an end thereof next to the master body with a transverse shaft having a breach at the middle of the transverse shaft. The pivot device comprises a pivot component and a fixing plate mounted to the pivot component. The fixing plate is mounted to the master body. The pivot component comprises a vertical shaft and a pivot sleeve fitted on the vertical shaft. Both sides of the pivot sleeve respectively have a fixed pin sleeved with a hinge unit that is connected to the transverse shaft. Each fixed pin is inserted into an insertion hole of each side of the breach of the screen. Both sides of an end of the master body next to the screen respectively have a fixing seat with an insertion pole. The insertion poles can be inserted into or removable from insertion holes of both ends of the transverse shaft of the screen. Therefore when the insertion poles are inserted into the insertion holes of the transverse shaft of the screen, the screen can only pivot around the transverse shaft. When the insertion poles are removable from the insertion holes of the transverse shaft, the screen can be made a little pivot in horizontal around the vertical shaft except being able to pivot around the transverse shaft. Because the pivot device is mounted to the master body and the screen through sleeve connections without any strengthening devices, this will cause bad pivot stability, insufficient strength and even a damage of the screen and the master body. Although the strength and stability thereof can be enhanced through the insertion pole of the fixing seat inserted into the insertion hole of the transverse shaft, this kind of design can work only in case of the screen in a normal position that means the screen not pivoted any angle around the vertical shaft. When the screen is pivoted an angle around the vertical shaft, it does not have any stability enhancement effect. In addition, because the pivot device does not have a design of position around as a passage of signal wires from the master body to the screen, it is impossible to pivot 360 degree for the screen and the master body relative to each other.

In view of this, an object of the present invention is to provide with a hinge for a notebook computer that makes the screen thereof not only be able to pivot 360 degree but also have a high pivot stability and strength and a design of position around as a passage of signal wires from the screen to the master body thereof.

### SUMMARY OF THE INVENTION

The present invention relates to a hinge for a notebook personal computer, which connects a screen to a master body of a notebook computer. The hinge can make the screen pivot in horizontal and in vertical relative to the master body.

A hinge of a preferred embodiment in accordance with the present invention comprises: a vertical pivot shaft mounted to a screen and a first connecting pivot seat through a plurality of springs and the corresponding nuts thereof, which enables the screen to pivot around the vertical pivot shaft relative to a master body of a notebook computer; a first connecting pivot seat mounted to the vertical pivot shaft and a horizontal pivot shaft; a horizontal pivot shaft mounted to the first connecting pivot seat and a second connecting pivot seat, comprising an outer sleeve and an inner pivot shaft that enables the screen to pivot in horizontal relative to the master body; and a second connecting pivot seat mounted to the horizontal pivot shaft and the master body.

Furthermore, the inner pivot shaft has a central through hole as a passage of signal wires from the master body of a notebook computer to the screen thereof so that the screen can be made a large angle pivot in horizontal relative to the master body.

In comparison with the prior art, the present invention has the following features:

(1) A hinge of a preferred embodiment in accordance with the present invention has a vertical and a horizontal pivot shafts that make a screen be able to pivot respectively in vertical and in horizontal relative to a master body of a notebook computer.

(2) The hinge of the present invention can make a notebook computer as the use of a tablet personal computer.

(3) The second connecting pivot seat of the hinge of the present invention has a plurality of screw holes, strengthening poles and a flange that make the hinge and a master body of a notebook computer securely mount together. And

(4) The inner pivot shaft of the hinge of the present invention has a central through hole as a passage of signal wires from the master body of a notebook computer to the screen thereof so that the screen can be made a large angle pivot in horizontal relative to the master body.

### BRIEF DESCRIPTION OF THE DRAWINGS

FIG. 1 is a schematic view of a hinge of the present invention installed on a notebook computer;

FIG. 2 is a perspective view of a hinge of a preferred embodiment in accordance with the present invention; and

FIGS. 3-5 are perspective views respectively showing different position states of the hinge of the present invention installed on a notebook computer.

### DETAILED DESCRIPTION OF THE PREFERRED EMBODIMENT

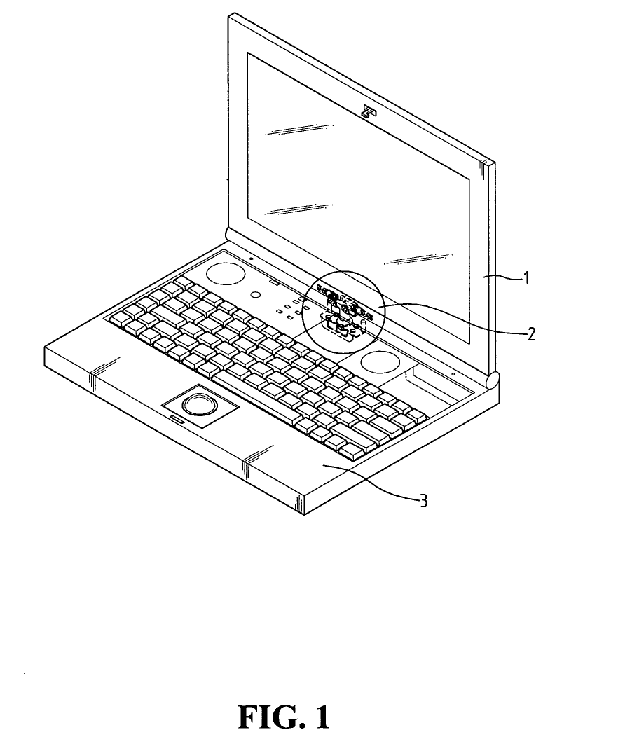

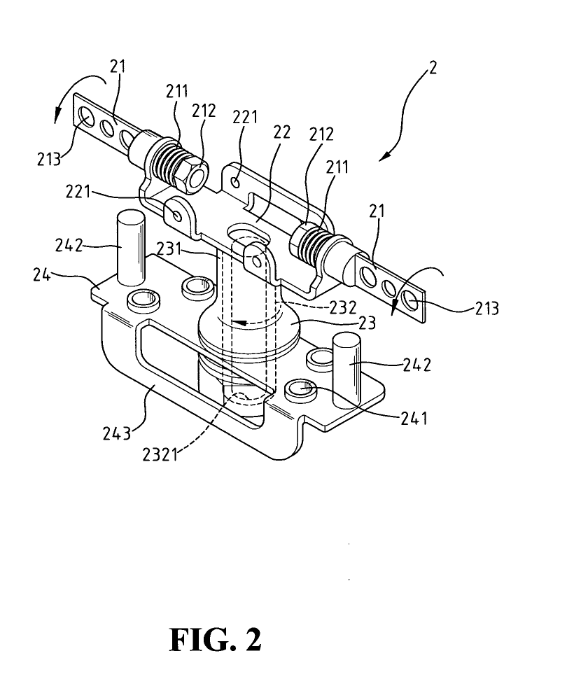

As shown in FIGS. 1 and 2, a hinge 2 of a preferred embodiment in accordance with the present invention mounts a screen 1 to a master body 3 of a notebook computer. The hinge 2 comprises at least a vertical pivot shaft 21, a first connecting pivot seat 22, a horizontal pivot shaft 23 and a second connecting pivot seat 24. The vertical pivot shaft 21 connects the screen 1 and the first connecting pivot seat 22 connected to the horizontal pivot shaft 23 connected to the second connecting pivot seat 24 that connects the master body 3.

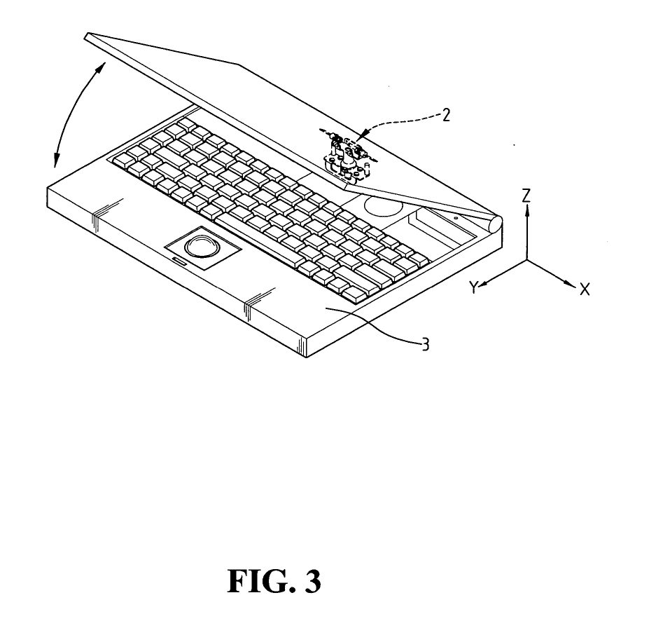

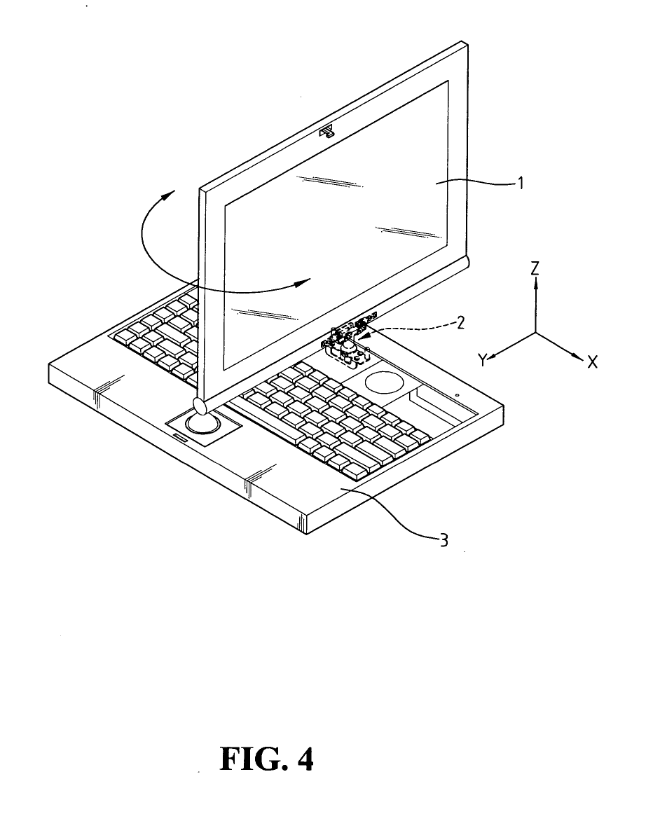

The vertical pivot shaft 21 is fixed to the first connecting pivot seat 22 through a plurality of springs 211 and the corresponding nuts 212 thereof. The vertical pivot shaft 21 has a plurality of screw holes 213 for securely screwing the screen 1 by the corresponding screws (not shown) thereof. Therefore the hinge 2 makes the screen 1 enable to pivot in vertical around the vertical pivot shaft 21 relative to the master body 3. As shown in FIG. 3, the screen 1 pivots in vertical around a horizontal axis (x-axis). The first connecting pivot seat 22 is provided on the both side flanges thereof with a plurality of screw holes 221 for securely screwing a cover (not shown) by the corresponding screws (not shown) thereof. The horizontal pivot shaft 23 comprises an outer sleeve 231 and an inner pivot shaft 232 that makes the screen 1 enable to pivot in horizontal around the horizontal pivot shaft 23 relative to the master body 3. As shown in FIG. 4, the screen 1 pivots in horizontal around a vertical axis (z-axis). The pivot shaft 232 has a central through hole 2321 as a passage of signal wires from the master body 3 to the screen 1. The second connecting pivot seat 24 has a plurality of screw holes 241 and strengthening poles 242 that are respectively screwed onto and engaged with the master body 3. The second connecting pivot seat 24 further has a side flange 243 engaged with the master body 3.

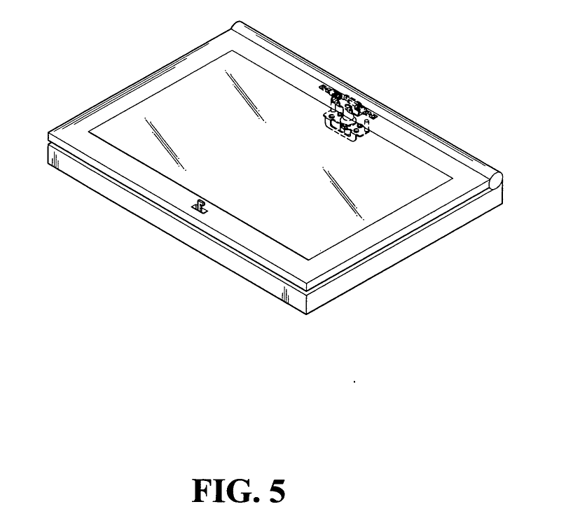

FIGS. 3 and 4 respectively show a hinge of the present invention being able to make a screen of a notebook computer pivot in vertical and in horizontal that provide users with various view angles. Referring to FIG. 5, the screen of a notebook computer can further be pivoted and turned upward as a tablet personal computer. Furthermore, the hinge of the present invention has multiple fixing devices to securely fix a screen of a notebook computer to a master body thereof, which can solve a probable shift between the screen and the master body.

The above statement is only for illustrating the preferred embodiment of the present invention, and not for giving any limitation to the scope of the present invention. It will be apparent to those skilled in this art that all equivalent modifications and changes shall fall within the scope of the appended claims and are intended to form part of this invention.

1. A hinge for notebook computer, which connects a screen to a master body of a notebook computer, comprising:
a vertical pivot shaft mounted to the screen and a first connecting pivot seat through a plurality of springs and the corresponding nuts thereof, which enables the screen to pivot around the vertical pivot shaft relative to the master body;
a first connecting pivot seat mounted to the vertical pivot shaft and a horizontal pivot shaft;
a horizontal pivot shaft mounted to the first connecting pivot seat and a second connecting pivot seat, comprising an outer sleeve and an inner pivot shaft that enables the screen to pivot in horizontal relative to the master body; and
a second connecting pivot seat mounted to the horizontal pivot shaft and the master body.

2. The hinge for notebook computer as claimed in claim 1, wherein the vertical pivot shaft has a plurality of screw holes for securely screwing the screen through the corresponding screws thereof.

3. The hinge for notebook computer as claimed in claim 1, wherein the second connecting pivot seat has a plurality of screw holes and strengthening poles for being respectively screwed onto and engaged with the master body; and the second connecting pivot seat further has a side flange engaged with the master body.

4. The hinge for notebook computer as claimed in claim 1, wherein the inner pivot shaft has a central through hole as a passage of signal wires from the master body to the screen.
